(19) United States
(12) Patent Application Publication
(10) Pub. No.: US 2004/0080756 A1
(43) Pub. Date: Apr. 29, 2004

(54) Surface profiler with vibration-damped horizontal reference surface

(76) Inventors: Phillip George Reid, Nedlands (AU); Hank Christian Sciberras, Joondanna (AU); Zheng Lin Wang, Glendalough (AU); Geoffrey Thomas Dair, Subiaco (AU)

Correspondence Address: MERCHANT & GOULD PC, P.O. BOX 2903, MINNEAPOLIS, MN, 55402-0903, US

(21) Appl. No.: 10/399,950

(22) PCT Filed: Oct. 19, 2001
(86) PCT No.: PCT/AU01/01340

(30) Foreign Application Priority Data
Oct. 19, 2000 (AU) PR 0861

(51) Int. Cl. G01B 11/02

(52) U.S. Cl. 356/512

(57) ABSTRACT

A beamsplitter (16) splits a source beam (14) into a sample path (17) and a reference path (19). The reflected beams recombine to form an interference signal (100). Reference surface (20) is horizontaly suspended on a loudspeaker membrane (30), and moved via a voice coil attached to the membrane (30). this arrangement isolates the reference surface (20) from external vibrations. The surface profile of the sample (18a) is analysed via the interference fringes, which are determined by computing maxima or minima in the statistical variance of digital data representing the interference signal (100). The apparatus may be used for calibrating laser ablation procedures in eye surgery.

### FIELD OF THE INVENTION

The present invention relates to surface profiling apparatus of the kind that relies on interferometry. As such, the apparatus has particular but by no means exclusive application to the profiling of polymer samples for calibrating laser ablation apparatus and/or for verifying a laser ablation procedure, for example in refractive eye surgery by photo-ablation.

### BACKGROUND ART

To ensure that the correct profile is etched onto a patient's cornea during photorefractive keratectomy (PRK) or laser insitu keratomeleusis (LASIK), the surgical laser must first be calibrated. This process imparts an accurate picture of how the laser will ablate the cornea. The corneal surface may be ablated to effect a myopic, hyperopic or astigmatic correction. Myopic corrections should produce a flatter curvature, while hyperopic corrections should remove more material around the edge of the area to be ablated.

International patent publication WO 99/04220, assigned to the present applicant, and international patent publication WO 99/01716 disclose methods and apparatus for surface profiling of polymer samples, typically in polymethyl methacrylate (PMMA), utilising an interferometric technique. An interference signal is formed from the recombination at a beam-splitter of components of a source beam respectively reflected or scattered from the sample surface and from a reference surface. The position of the reference surface is translated, by means including a voice coil driver, so as to give rise to detectable interference fringes.

A compact and effective instrument has been developed utilising the configuration disclosed in international patent application WO 99/04220 but it has been found that the operation of the instrument is very sensitive to vibrations in the vicinity of the instrument. It is an objective of the present invention to provide one or more modifications or improvements to at least in part alleviate the problem.

### SUMMARY OF INVENTION

The present invention is directed in various aspects to a number of improvements and modifications which may be utilised alone or in combinations of two or more of the improvements and modifications to obtain improved profiling apparatus.

In general, the invention is directed to a surface profiling apparatus for measuring the surface profile of a sample, which apparatus includes:

at least one light source for generating a source beam;

beamsplitter means positioned in the path of the source beam for splitting the source beam into split beams;

a reference surface positioned to reflect or scatter one of said split beams back to said beamsplitter means;

a holder for positioning a sample so that a surface of the sample reflects or scatters another of said split beams back to said beamsplitter means for forming, with said one reflected or scattered beam, an interference signal; and

reference surface positioning means optionally including a voice coil driver for positioning the reference surface.

In a first aspect of the invention, the reference surface is arranged to be disposed generally horizontally in operation of the apparatus. In the configurations of the aforementioned international patent publications, both the sample surface and the reference surface were disposed generally upright. It has been realised by the present inventors that this orientation renders the reference surface in particular more susceptible to vibrations and to positioning inaccuracies of the reference surface, and therefore to inaccuracies in the interference signal, once the reference surface or other components of the means for adjusting its position, alter their orientation with respect to the vertical or horizontal. These problems are substantially alleviated by the first aspect of the invention.

In a second aspect, the reference surface positioning means includes a membrane coupled to said voice coil driver for displacement thereby, and the reference surface is mounted to a support carried in turn by the membrane.

In a particularly convenient embodiment of this second aspect of the invention, the membrane is a shallow dish-shaped membrane of a loudspeaker also including the voice coil driver. In this embodiment, the support for the reference surface is a seat mounted substantially at the centre of the membrane, which itself is preferably oriented generally horizontally so that the membrane serves as a vibration dampening mount for the supported reference surface.

Advantageously, the membrane is supported within a sealed cavity providing an air damper for the membrane and thereby for the reference surface.

In accordance with a third aspect of the invention, the reference surface is suspended from a peripheral rim, for thereby damping transmission of external vibrations to the reference surface. In a particularly advantageous combination of the first, second and third aspects of the invention, a loudspeaker assembly incorporating the voice coil and its membrane, the latter effectively sealed within an air damper, is suspended from a peripheral mount so that the membrane lies in a generally horizontal orientation.

Preferably, the aforedefined surface profiling apparatus further includes means for imaging the interference signal and means for determining therefrom the surface profile of the sample surface. The imaging means might typically comprise a CCD video camera. The means for determining the surface profile typically includes computer means for controlling the reference surface, analysing the interference signal data received from the imaging means and detecting fringes in the interference signal, eg maxima or minima. The conventional analysis for this purpose involves the detection of maxima of the data arranged to represent a generally sinusoidal pattern. This technique usually involves spectral analysis of the digital data. In accordance with a fourth aspect of the invention, it has been appreciated that this approach is unnecessary and that the maxima or minima modulation of the interference signal can be reliably identified by the statistical variance of digital data representing the interference signal.

In accordance with this fourth aspect of the invention, accordingly, the means for determining the surface profile includes means for detecting maxima or minima in said interference signal by detecting maxima or minima in the statistical variance of digital data representing the interference signal. The invention further extends to a computer program product comprising stored machine readable instructions for determining maxima or minima in an optical interference signal by detecting maxima or minima in the statistical variance of digital data representing the interference signal.

### BRIEF DESCRIPTION OF THE DRAWINGS

The invention will now be further described, by way of example only, with reference to the accompanying drawings, in which:

FIG. 1 is a diagram of the optical layout of surface profiling apparatus in accordance with an embodiment of the invention;

FIG. 2 is a fragmentary view of the assembly of the loudspeaker and the supported reference surface, shown without the speaker housing;

FIG. 3 is an axial cross-section of the loudspeaker assembly;

FIG. 4 illustrates the annular holder for the speaker/reference surface assembly; and

FIG. 5 is a perspective view of the sample holder in the apparatus depicted in FIG. 1.

### PREFERRED EMBODIMENTS

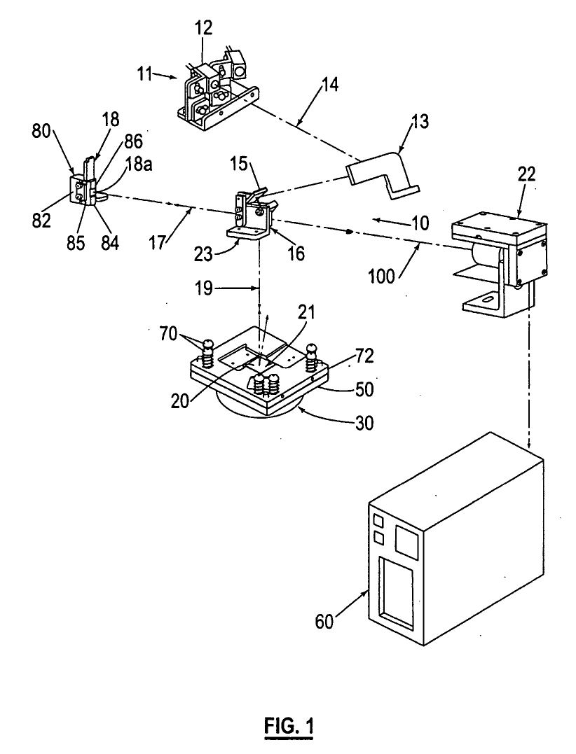

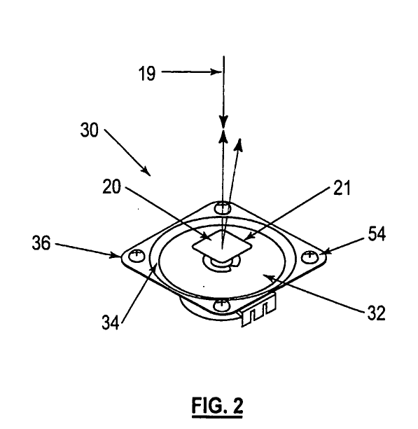

FIG. 1 illustrates the essential optical configuration of a surface profiling apparatus 10 according to an embodiment of the present invention. A red or infrared light beam 14 is generated by a pair of light emitting diodes 12, of a source stage 11 and is incident via mirrors 13, 15 onto a beamsplitter 16 from which emerge a laterally directed component beam 17 and a downwardly directed component beam 19. Mirror 15 and beamsplitter 16 are supported on a common optical mount 23.

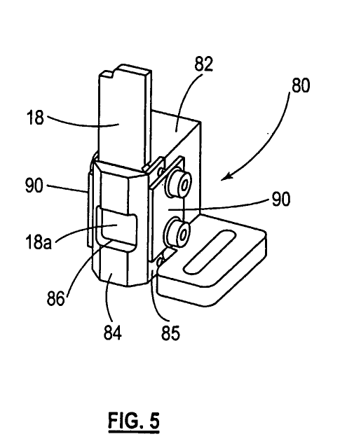

Laterally directed beam 17 is incident on, and reflected and scattered by, an ablated sample 18 held by a sample holder 80. The sample 18 might typically be a piece of a suitable plastic polymer, eg PMMA, that ablates at a known rate, relative to the corneal tissue for which the test is being conducted, over a range of laser fluencies used in corneal ablation procedures. Sample 18 is an elongate flat strip held on a first face of holder body 82 by a u-shaped retainer 84 (FIG. 5). Retainer 84 has side flanges 85 that seat in matching rebates in the sides of body 82, and a front window 86 that exposes an adjustable portion 18a of the sample to receive and scatter beam 17.

The downwardly directed second component beam 19 emerging from the beamsplitter is directed onto a reference surface 20 provided by the upper face of a glass slide 21 which is scanned vertically by means to be described. Typically, beam 19 is oriented at an angle slightly different from 90° to reference surface 20 and is not in this instance acting as a specular mirror. Light scattered back to and through beamsplitter 16 from reference surface 20 is consequently combined with light reflected or scattered from the surface of sample 18 and reflected at beamsplitter 16. The combined beam 100 is passed to a detector such as a CCD video camera 22.

The two light sources 12 of source stage 11 are alternated in operation of the apparatus in order to overcome possible saturation of some portions of the image from camera 22.

Vertical scanning of reference surface 20 correspondingly varies the beam path length of the scattered light returned to beamsplitter 16. Interference fringes will therefore be formed when the path lengths of the two components of the combined beam 100 match. For determining the surface profile, the output of camera 22 is fed to a computer 60. As mentioned, the conventional analysis for this purpose involves the detection of maxima or minima of the data arranged to represent a generally sinusoidal pattern. It has been appreciated that this approach is unnecessary and that the maxima or minima in the interference signal can be reliably identified by detecting maxima or minima in the statistical variance of digital data from camera 22 representing the interference signal.

Computer 60 can calculate the shape of the ablated sample surface 18, display the shape in a three dimensional form, compare the actual shape to a desired shape and issue a “go/no go” message, indicating that a good calibration or a laser problem has been detected, respectively. The computer may also be joined to a laser system or corneal topography device. The calibration device can therefore exchange information concerning the ablated profile with the laser system. The information provided about the measured profile produced can then be interpreted, and used to alter the parameters of the laser system so that the desired corneal profile is produced in its next ablation.

Apparatus for performing topographic profiling of the cornea may also be included in a preferred embodiment. This apparatus may be used to measure the original profile of the corneal surface and then import the measured ablation profile from the calibration apparatus of the present invention. The corneal topography that may be expected if a laser ablation procedure were performed on a cornea, based on the calibration data, may then be calculated and displayed. Alternatively, the calibration apparatus may read the corneal topographic data, and calculate and display on computer 60 the resultant corneal shape that would be created if the laser was used on the eye.

For an ablated sample such as those used in preparation for laser refractive eye surgery, circular interference patterns are observed for good, non-astigmatic myopic ablations. A smaller circular pattern is produced at the deepest point of the ablated surface when the reference surface 20 is furthest away from beam-splitter 16. Progressively larger circular patterns are produced as shallower ablations are encountered.

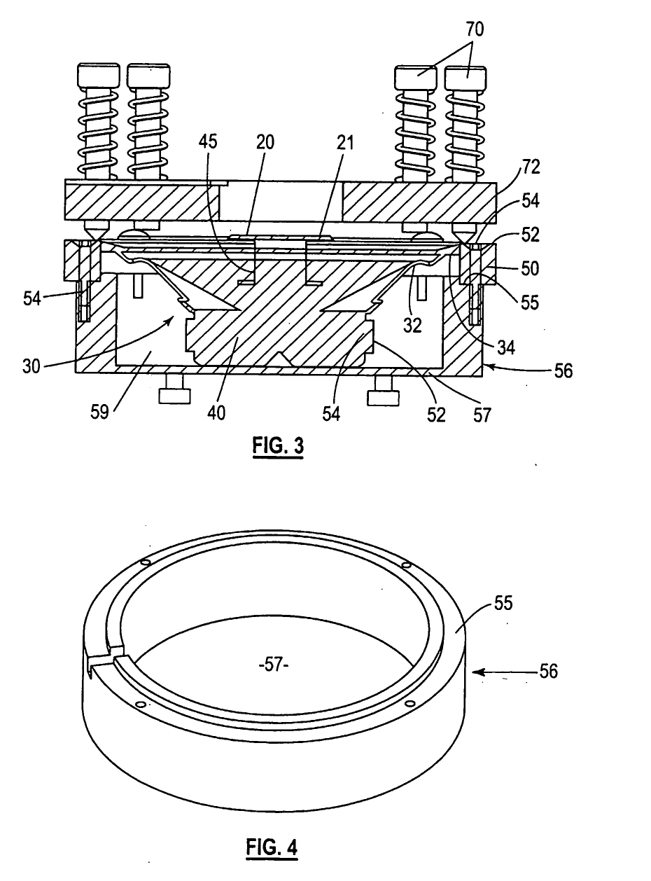

Scanning of reference surface 20 is effected by appropriate ramp activation of the voice coil of a loudspeaker assembly 30 on which glass slide 21 is mounted. The loudspeaker includes the usual dish-shaped membrane 32 with inclined rim 34 which is fastened to a peripheral rigid flange 36. The centre of membrane 32 is attached (FIG. 3) on its rear face to a lightweight sleeve 52 which carries an annular electromagnetic voice coil 54 of electrically conductive wire about a fixed cylindrical magnet 40. In the conventional use of the unit as a loudspeaker, the application of a modulated electrical signal to the voice coil 54 in the presence of the fixed magnetic field induces a vibration in membrane 32 which generates a sound output. In the present case, instead, the electrical signal is applied to cause the membrane to drive the reference surface in a linear ramp. On the centre front of the membrane is a lightweight mounting seat 45. One flange of the seat is fixed to the membrane and the other to glass slide 21. It will thus be appreciated that application of an appropriate electrical signal to the voice coil 54 of the loudspeaker 30 will cause vertical scanning oscillation of glass slide 21 and therefore of reference surface 20.

Loudspeaker assembly 30 is suspended from the upper surface 52 of a cover plate 50 by attaching flange 36 of the loud speaker assembly atop the plate 50 by a set of screws 54. This cover plate is in turn fixed, by the same screws 54, in a peripheral rebate 55 of an annular holder 56 (FIG. 4) with a closed floor 57. Holder 56 is dimensioned so that the speaker assembly 30 is suspended within the holder just clear of floor 57. The clamping of the speaker flange 36 onto plate 50 creates a sealed cavity 59 within the holder about the membrane 32, which provides an additional air damper for the membrane and reference surface. This assembly is further stabilised with respect to an overlying plate 72 by spring-loaded adjustment screws 70.

A suitable arrangement is provided for measuring a relative set position for the depth of the sample cut as a calibration step. A plurality, usually a pair of known or standard surfaces is defined by shims 90 bolted to the sides of sample holder 80 at a slight angle to each other (not evident in FIG. 5), and is measured simultaneously with the sample 18. A transformation is then calculated to convert the measured raw data from the standard surfaces to the known (calibrated) data. This transformation is then applied to the sample 18 to determine the true depth of the sample.

The measures of mounting reference surface 20 generally horizontally, providing for membrane 32 to be activated by the voice coil, and suspending the assembly from plate 50 within holder 56 all assist in isolating the reference surface from the effect of environmental vibrations in the apparatus and surrounds. Further benefit in this respect is gained by the sealing of membrane 32 within air sealed cavity 59 to provide an air damper for the membrane and the reference surface.

1 Surface profiling apparatus for measuring the surface profile of a sample, which apparatus includes:
a least one light source for generating a source beam;
beamsplitter means positioned in the path of the source beam for splitting the source beam into split beams;
a reference surface positioned to reflect or scatter one of said split beams back to said beamsplitter means;
means to dispose said reference surface generally horizontally in operation of the apparatus;
a holder for positioning a sample so that a surface of the sample reflects or scatters another of said split beams back to said beamsplitter means for forming, with said one reflected or scattered beam, an interference signal; and
reference surface positioning means for positioning the reference surface.

2 Surface profiling apparatus according to claim 1 wherein said reference surface positioning means includes a voice coil driver.

3 Surface profiling apparatus according to claim 2 wherein said reference surface positioning means further includes a membrane coupled to said voice coil driver for displacement thereby, and said reference surface is mounted to a support carried in turn by the membrane.

4 Surface profiling apparatus according to claim 3 wherein said membrane is a shallow dish-shaped membrane of a loudspeaker also including the voice coil driver, and said means to dispose said reference surface generally horizontally includes a seat mounted substantially at the centre of the membrane.

5 Surface profiling apparatus according to claim 4 wherein said membrane is oriented generally horizontally so that the membrane serves as a vibration dampening mount for the supported reference surface.

6 Surface profiling apparatus according to any claim 3, 4 or 5 wherein said membrane is supported within a sealed cavity providing an air damper for the membrane and thereby for the reference surface.

7 Surface profiling apparatus according to any one of claims 1 to 6 wherein said reference surface is suspended from a peripheral rim, for thereby damping transmission of external vibrations to the reference surface.

8 Surface profiling apparatus according to claim 3 further including a loudspeaker assembly incorporating the voice coil and said membrane, the latter effectively sealed within an air damper, which loudspeaker assembly is suspended from a peripheral mount so that the membrane lies in a generally horizontal orientation.

9 Surface profiling apparatus according to any one of claims 1 to 8 further including means for imaging the interference signal and means for determining therefrom the surface profile of the sample surface.

10 Surface profiling apparatus according to claim 10, wherein said means for determining the surface profile includes means for detecting maxima or minima in said interference signal by detecting maxima or minima in the statistical variance of digital data representing the interference signal.

11 Surface profiling apparatus for measuring the surface profile of a sample, which apparatus includes:
At least one light source for generating a source beam;
beamsplitter means positioned in the path of the source beam for splitting the source beam into split beams;
a reference surface positioned to reflect or scatter one of said split beams back to said beamsplitter means;
a holder for positioning a sample so that a surface of the sample reflects or scatters another of said split beams back to said beamsplitter means for forming, with said one reflected or scattered beam, an interference signal; and
reference surface positioning means for positioning the reference surface, which reference surface positioning means includes a voice coil driver and a membrane coupled to said voice coil driver for displacement thereby, said reference surface being mounted to a support carried in turn by the membrane.

12 Surface profiling apparatus according to claim 11 wherein said membrane is a shallow dish-shaped membrane of a loudspeaker also including the voice coil driver, and said means to dispose said reference surface generally horizontally includes a seat mounted substantially at the centre of the membrane.

13 Surface profiling apparatus according to claim 12 wherein said membrane is oriented generally horizontally so that the membrane serves as a vibration dampening mount for the supported reference surface.

14 Surface profiling apparatus according to any claim 11, 12 or 13 wherein said membrane is supported within a sealed cavity providing an air damper for the membrane and thereby for the reference surface.

15 Surface profiling apparatus according to any one of claims 11 to 14 wherein said reference surface is suspended from a peripheral rim, for thereby damping transmission of external vibrations to the reference surface.

16 Surface profiling apparatus according to claim 11 further including a loudspeaker assembly incorporating the voice coil and said membrane, the latter effectively sealed within an air damper, which loudspeaker assembly is suspended from a peripheral mount so that the membrane lies in a generally horizontal orientation.

17 Surface profiling apparatus according to any one of claims 11 to 16 further including means for imaging the interference signal and means for determining therefrom the surface profile of the sample surface.

18 Surface profiling apparatus according to claim 17, wherein said means for determining the surface profile includes means for detecting maxima or minima in said interference signal by detecting maxima or minima in the statistical variance of digital data representing the interference signal.

19 Surface profiling apparatus for measuring the surface profile of a sample, which apparatus includes:
at least one light source for generating a source beam;
beamsplitter means positioned in the path of the source beam for splitting the source beam into split beams;
a reference surface positioned to reflect or scatter one of said split beams back to said beamsplitter means;
a holder for positioning a sample so that a surface of the sample reflects or scatters another of said split beams back to said beamsplitter means for forming, with said one reflected or scattered beam, an interference signal; and
reference surface positioning means for positioning the reference surface;
wherein said reference surface is suspended from a peripheral rim, for thereby damping transmission of external vibrations to the reference surface.

20 Surface profiling apparatus according to claim 19 further including means for imaging the interference signal and means for determining therefrom the surface profile of the sample surface.

21 Surface profiling apparatus according to claim 20, wherein said means for determining the surface profile includes means for detecting maxima or minima in said interference signal by detecting maxima or minima in the statistical variance of digital data representing the interference signal.

22 Surface profiling apparatus for measuring the surface profile of a sample, which apparatus includes:
at least one light source for generating a source beam;
beamsplitter means positioned in the path of the source beam for splitting the source beam into split beams;
a reference surface positioned to reflect or scatter one of said split beams back to said beamsplitter means;
a holder for positioning a sample so that a surface of the sample reflects or scatters another of said split beams back to said beamsplitter means for forming, with said one reflected or scattered beam, an interference signal; and
reference surface positioning means for positioning the reference surface; and
means for imaging the interference signal and means for determining therefrom the surface profile of the sample surface;
wherein said means for determining the surface profile includes means for detecting maxima or minima in said interference signal by detecting maxima or minima in the statistical variance of digital data representing the interference signal.

23 A computer program product comprising stored machine readable instructions for determining maxima or minima in an optical interference signal by detecting maxima or minima in the statistical variance of digital data representing the interference signal.
